(19) United States
(12) Patent Application Publication
(10) Pub. No.: US 2024/0253138 A1
(43) Pub. Date: Aug. 1, 2024

(54) BAND SAW INCLUDING TOUCH SENSORS

(71) Applicant: MILWAUKEE ELECTRIC TOOL CORPORATION, Brookfield, WI (US)

(72) Inventor: William Booth Howarth, Milwaukee, WI (US)

(21) Appl. No.: 18/428,015

(22) Filed: Jan. 31, 2024

Related U.S. Application Data
(60) Provisional application No. 63/500,367, filed on May 5, 2023.
(60) Provisional application No. 63/482,359, filed on Jan. 31, 2023.

(51) Int. Cl. B23D 53/12; B23D 59/00; H02K 7/14; H02K 11/28; H02P 7/22

(52) U.S. Cl. CPC B23D 53/12; B23D 59/001; H02K 7/145; H02K 11/28; H02P 7/22

(57) ABSTRACT

A band saw having a touch sensor. An example band saw includes a housing, a motor, a first handle including a first trigger configured to be actuated by a user, a second handle including a touch sensor, and a controller connected to the motor, the first trigger, and the touch sensor. A first hand of the user may be detected on the first handle based on actuation or de-actuation of the first trigger. The touch sensor is configured to detect a second hand of the user on the second handle. The controller is configured to determine that the touch sensor is actuated by the user, determine that the first trigger is actuated by the user after the touch sensor is actuated by the user, and drive, in response to the touch sensor being actuated and the first trigger sensor being actuated after the touch sensor is actuated, the motor.

### RELATED APPLICATIONS

This application claims the benefit of U.S. Provisional Patent Application No. 63/500,367, filed May 5, 2023, and U.S. Provisional Patent Application No. 63/482,359, filed Jan. 31, 2023, the entire content of each of which is hereby incorporated by reference.

### FIELD

Embodiments described herein provide a portable band saw.

### SUMMARY

Embodiments described herein provide a band saw including a housing and a motor located within the housing. The band saw includes a first handle and a second handle. The first handle includes a first trigger configured to be actuated by a user. A first hand of the user may be detected on the first handle based on actuation or de-actuation of the first trigger. The second handle includes a touch sensor (e.g., a capacitive touch sensor). The touch sensor is configured to detect a second hand of the user on the second handle. The band saw includes a controller operable to control operation of the motor and monitor for the actuation state of both the first trigger and the touch sensor. When the touch sensor is in an actuated state and is followed by the first trigger being in an actuated state, the controller drives the motor. When the first trigger is in an actuated state and is followed by the touch sensor being in an actuated state, the controller prohibits operation of the motor.

Band saws described herein include a housing, a motor located within the housing, a first handle including a first trigger configured to be actuated by a user, a second handle including a touch sensor, and a controller connected to the motor, the first trigger, and the touch sensor. A first hand of the user may be detected on the first handle based on actuation or de-actuation of the first trigger. The touch sensor is configured to detect a second hand of the user on the second handle. The controller is configured to determine that the touch sensor is actuated by the user, determine that the first trigger is actuated by the user after the touch sensor is actuated by the user, and drive, in response to the touch sensor being actuated and in response to the first trigger sensor being actuated after the touch sensor is actuated, the motor.

In some aspects, the controller is further configured to determine, while the motor is being driven, that the first trigger is released by the user, and stop, in response to the first trigger being released, driving the motor.

In some aspects, the controller is further configured to determine, while the motor is being driven, that the touch sensor is released by the user, and stop, in response to the touch sensor being released, driving the motor.

In some aspects, the band saw further includes an indicator configured to provide an indication, and wherein the controller is further configured to prohibit, in response to the touch sensor being released while the first trigger remains actuated, operation of the motor, and control, in response to the touch sensor being released while the first trigger remains actuated, the indicator to provide an indication.

In some aspects, the controller is further configured to determine that the touch sensor is actuated by the user while the first trigger remains actuated, and continue, in response to determining that the touch sensor is actuated by the user while the first trigger remains actuated, prohibiting operation of the motor.

In some aspects, the controller is further configured to determine that the first trigger is released by the user, and permit, in response to the first trigger being released and the touch sensor being released, operation of the motor.

In some aspects, to determine that the touch sensor is actuated by the user, the controller is configured to set, in response to initiation of a wake sequence, an initialization flag, compare a capacitance timer to a time threshold, compare, in response to the capacitance timer satisfying the time threshold, a capacitance value of the touch sensor to a capacitance threshold, and determine, in response to the capacitance value satisfying the capacitance threshold, that the touch sensor is actuated by the user.

In some aspects, the controller is further configured to increment, in response to the capacitance timer not satisfying the time threshold, the capacitance timer.

In some aspects, the housing includes an external portion configured as a heatsink.

In some aspects, the housing includes a recessed portion configured to receive a printed circuit board and a thermally conductive pad situated between the external portion and the printed circuit board.

In some aspects, the touch sensor is an impedance sensor.

Methods for controlling a band saw described herein include determining that a touch sensor is actuated by a user, determining that a first trigger is actuated by the user after the touch sensor is actuated by the user, and driving, in response to the touch sensor being actuated and in response to the first trigger sensor being actuated after the touch sensor is actuated, a motor. The touch sensor is configured to detect a second hand of the user on a second handle. A first hand of the user may be detected on a first handle based on actuation or de-actuation of the first trigger.

In some aspects, the method further includes determining, while the motor is being driven, that the first trigger is released by the user, and stopping, in response to the first trigger being released, driving the motor.

In some aspects, the method further includes determining, while the motor is being driven, that the touch sensor is released by the user, and stopping, in response to the touch sensor being released, driving the motor.

In some aspects, the method further includes prohibiting, in response to the touch sensor being released while the first trigger remains actuated, operation of the motor, and controlling, in response to the touch sensor being released while the first trigger remains actuated, an indicator to provide an indication.

In some aspects, the method further includes determining that the touch sensor is actuated by the user while the first trigger remains actuated, and continuing, in response to determining that the touch sensor is actuated by the user while the first trigger remains actuated, prohibiting operation of the motor.

In some aspects, the method further includes determining that the first trigger is released by the user, and permitting, in response to the first trigger being released and the touch sensor being released, operation of the motor.

Band saws described herein include a housing, a motor located within the housing, a first handle including a first trigger configured to be actuated by a user, a second handle including an impedance sensor, and a controller connected to the motor, the first trigger, and the impedance sensor. A first hand of the user may be detected on the first handle based on actuation or de-actuation of the first trigger. The impedance sensor is configured to detect a second hand of the user on the second handle. The controller is configured to determine, based on changes in resistive and reactive components of an impedance value provided by the impedance sensor, that the impedance sensor is actuated by the user, determine that the first trigger is actuated by the user after the impedance sensor is actuated by the user, and drive, in response to the impedance sensor being actuated and in response to the first trigger sensor being actuated after the impedance sensor is actuated, the motor.

In some aspects, the housing includes an external portion configured as a heatsink.

In some aspects, the housing includes a recessed portion configured to receive a printed circuit board and a thermally conductive pad situated between the external portion and the printed circuit board.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1A illustrates a perspective view of a portable band saw, according to embodiments described herein.

FIG. 1B illustrates a perspective view of another portable band saw, according to embodiments described herein.

FIG. 1C illustrates a cross-section of the portable band saw of FIG. 1A, according to embodiments described herein.

FIGS. 2A-2C illustrate perspective views of a secondary handle of the portable band saw of FIG. 1A, according to embodiments described herein.

FIG. 3 illustrates a controller for the portable band saw of FIG. 1A or FIG. 1B, according to embodiments described herein.

FIG. 4 illustrates a method performed by the controller of FIG. 3, according to embodiments described herein.

FIG. 5 illustrates a state diagram for the portable band saw of FIG. 1A or FIG. 1B, according to embodiments described herein.

FIG. 6 illustrates another method performed by the controller of FIG. 3, according to embodiments described herein.

FIG. 7 illustrates a housing portion of a power tool configured as a heatsink, according to embodiments described herein.

FIG. 8 illustrates an impedance sensor for the portable band saw of FIG. 1A or FIG. 1B, according to some embodiments.

FIG. 9 illustrates a relationship between resistance and reactance for the impedance sensor of FIG. 8, according to some embodiments.

### DETAILED DESCRIPTION

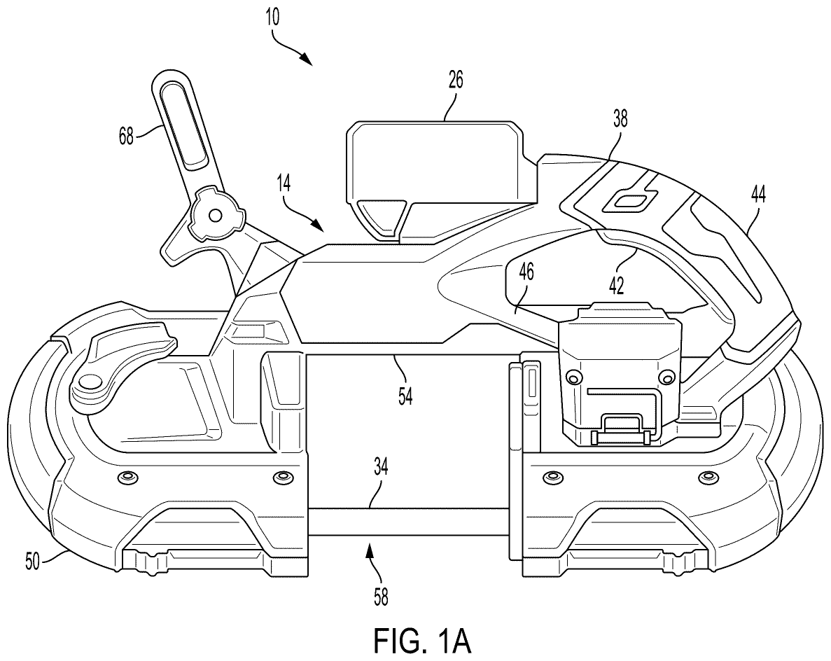

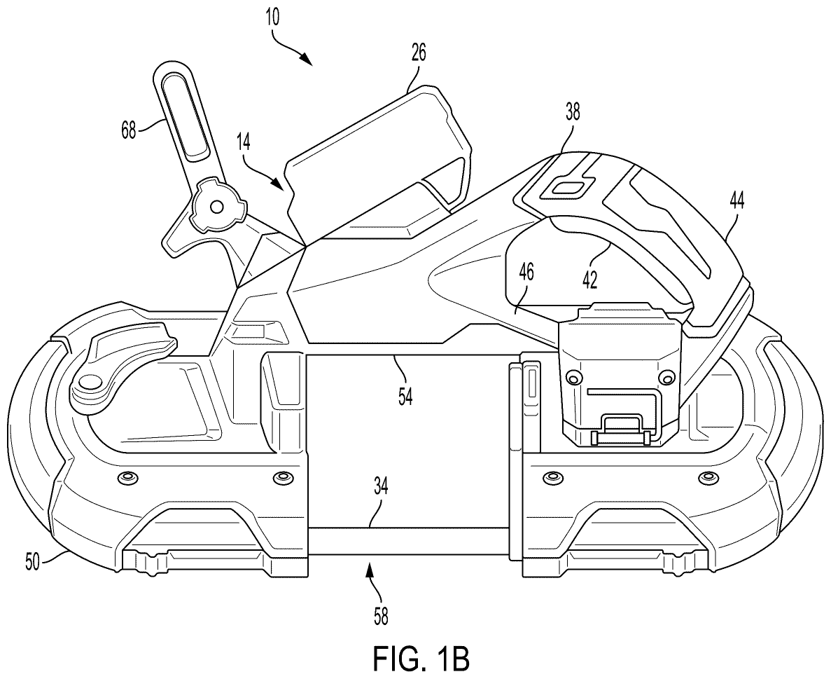

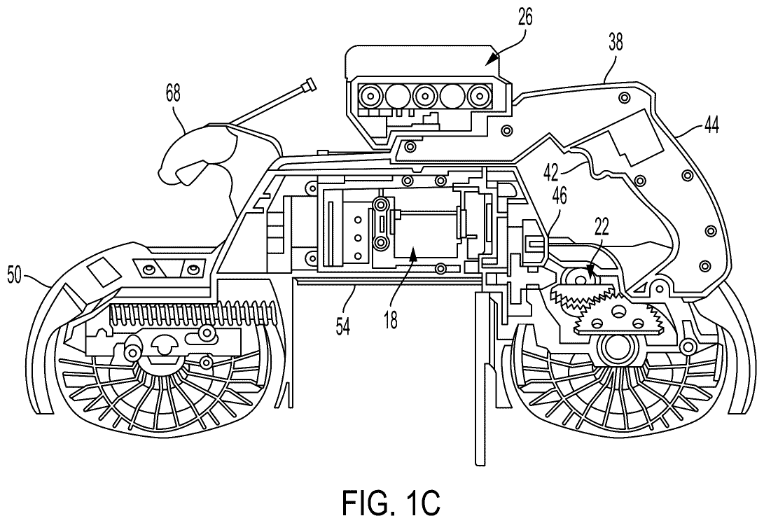

FIGS. 1A-1C illustrate a band saw 10 including a frame or housing 14 supporting a motor 18 and a gear box 22 (see FIG. 1C). In the illustrated example of the band saw 10, the motor 18 is configured as a DC brushless motor, and the band saw 10 is configured to receive a removable and rechargeable battery pack 26 for supplying power to the band saw 10. FIGS. 1A and FIGS. 1B provide different example locations of the battery pack 26 connected to the band saw 10. The motor 18 is drivingly connected to a drive assembly through a gear box 22. The motor 18, the drive assembly, and the gear box 22 are supported by the housing 14. The drive assembly may include any of a number of bearing arrangements and different gear train arrangements configured to provide various speed and torque outputs. The motor 18 and the drive assembly are operable to drive a continuous band saw blade 34 to cut a workpiece.

The housing 14 includes a primary handle 38 with a primary switch or primary trigger 42 to provide power to the band saw 10. The primary trigger 42 is disposed adjacent a gripping portion 44 of the primary handle 38 where a user grasps the band saw 10. In the example of FIG. 1A, the battery pack 26 is supported by the primary handle 38 and is an 18-volt power tool battery pack 26. In other embodiments, such as that shown in the example of FIG. 1B, the battery pack 26 may be supported on the housing 14. The primary trigger 42 is operable to control operation of the motor 18. Specifically, the battery pack 26 selectively supplies power to the motor 18 based on an actuation of the primary trigger 42.

The housing 14 of the band saw 10 also includes a deck 46 and a guard 50 coupled to the deck 46. A combination of the deck 46 and the guard 50 defines an opening or cavity 54 (e.g., a U-shaped cavity). The guard 50 includes a lip (not shown) that provides a recessed area in which the band saw blade 34 is positioned. The guard 50 substantially covers the band saw blade 34 when the blade 34 is in a shielded position (i.e., when the blade 34 is outside of a cut zone 58). The cavity 54 enables the band saw blade 34 to be in an exposed position (i.e., when the blade 34 passes through the cut zone 58). In the exposed position, the blade 34 is fully exposed and unobstructed by the guard 50, allowing workpieces to be cut when entering the cut zone 58.

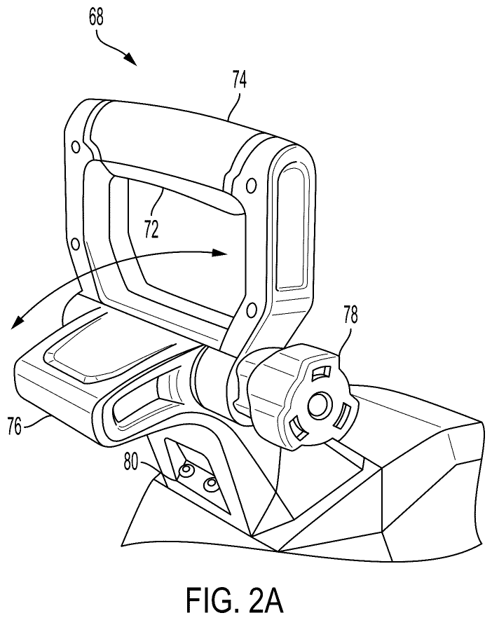

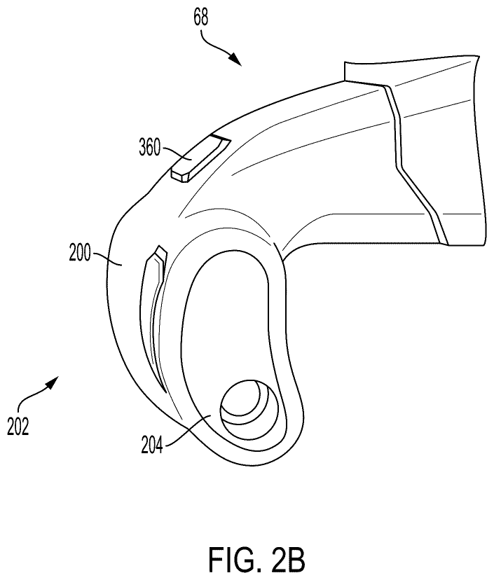

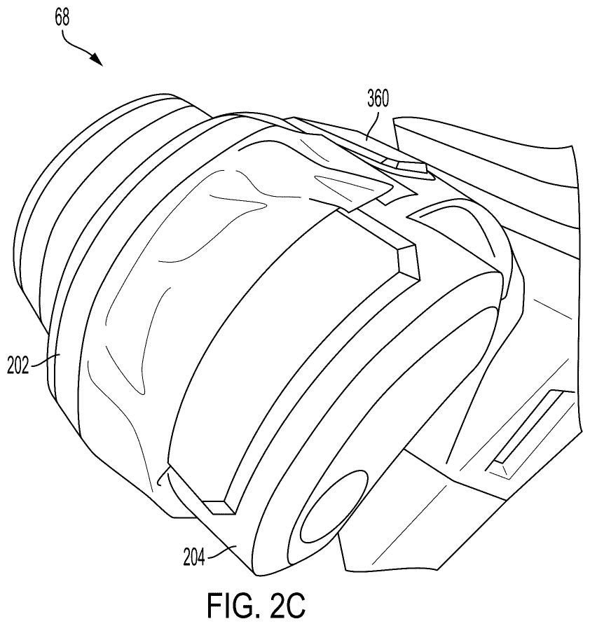

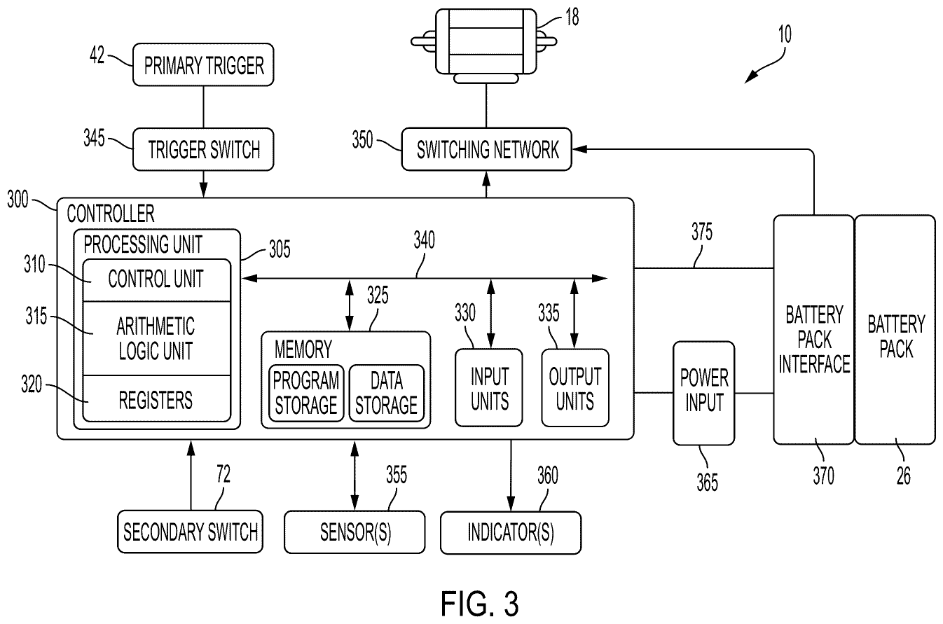

The band saw 10 also includes a secondary handle 68 with a secondary trigger or secondary switch 72, shown in detail in FIG. 2A. The secondary switch 72 is adjacent to a secondary gripping portion 74. The secondary switch 72 may be, for example, a touch sensor configured to detect whether a user is gripping the secondary handle 68, as described below in more detail. In some embodiments, the secondary switch 72 is a capacitive sensor. The capacitive sensor may include a sensing probe formed of unshielded wire routed from the controller 300 (see FIG. 3) and coiled in the secondary handle 68 to detect the presence of an operator's hand. In some instances, the band saw 10 includes a reference capacitance (e.g., mounted on a printed circuit board) that can be used to mitigate or eliminate measurement drift due to common-mode environmental factors. In some instances, the capacitive sensor may also include a reference probe formed of a shielded copper pour configured to detect capacitance levels due to environmental conditions. In some embodiments, two or more capacitive sensors are integrated in the secondary handle 68 to detect an operator's hand.

In some instances, the secondary handle 68 may be placed or held flat against a metal surface, such as metal surface 202 (shown in FIG. 2B), thereby causing the secondary switch 72 to contact or come in proximity to the metal surface. In such an instance, the metal surface 202 may cause a current response in the secondary switch 72, resulting in undesired actuation of the secondary switch 72 (e.g., the inaccurate detection that a user is gripping the secondary handle 68). Accordingly, in some embodiments, the secondary handle 68 includes a rib, projection, or other obstacle 200 that blocks the secondary switch 72 from contacting an exterior surface when the band saw 10 is situated on the exterior surface, as shown in FIGS. 2B-2C. For example, the obstacle 200 prevents contact between the secondary switch 72 and the metal surface 202. As another example, the obstacle 200 creates a distance between the metal surface 202 and the secondary switch 72, thereby reducing the capacitance generated by the metal surface 202 on the secondary switch 72. The obstacle 200 may be designed such that a user can still grip the secondary handle 68 and contact the secondary switch 72. In some embodiments, the secondary handle 68 also includes a sensor cover 204 that covers the secondary switch 72.

In some instances, the secondary handle 68 includes a projection 76 configured to support a workpiece to be cut by the band saw 10. The secondary handle 68 may include an adjusting knob 78 configured such that rotation of the adjusting knob adjusts a position of the secondary handle 68, the projection 76, or a combination thereof. In some embodiments, the secondary handle 68 is removably connected to the housing 14 via one or more fasteners 80 (e.g., screws). In some embodiments, as shown in FIGS. 1A, 1B, and 2A the secondary handle 68 is configured as a D-handle. In other embodiments, the secondary handle 68 may be configured as a pommel, as shown in FIG. 1C and FIGS. 2B-2C.

FIG. 3 illustrates a controller 300 for the band saw 10. The controller 300 is electrically and/or communicatively connected to a variety of modules or component of the band saw 10. For example, the illustrated controller 300 is connected to indicators 360, sensors 355 (which may include, for example, a pressure sensor, a speed sensor, a current sensor, a voltage sensor, a position sensor, etc.), the primary trigger 42, a trigger switch 345, a switching network 350, a power input unit 365, the motor 18, and the secondary switch 72. In some embodiments, the sensors 355 include one or more capacitive sensors and/or one or more impedance sensors (e.g., an impedance sensing integrated circuit). A capacitance sensor or an impedance sensor can be used to detect, for example, a type of material that the band saw 10 is cutting, an accessory (e.g., a blade, a handle, etc.) connected to the band saw 10, etc. Such sensors would not require direct contact with rotating portions of the band saw 10 to detect the type of material being cut, the attached accessory, etc. In some embodiments, the secondary switch 72 can be implemented using an impedance sensor. In some embodiments, the material being cut can have its own distinct electrical characteristics (e.g., capacitance, impedance, etc.). As a result, the material being cut can affect a capacitance or impedance of an accessory being used to make the cut (e.g., a saw blade). Such variations or changes in capacitance or impedance can be used to identify the material that is being cut. For example, cutting a wooden material will have one affect on capacitance or impedance of the accessory, and human flesh will have a different affect on capacitance or impedance of the accessory. Depending on the detected type of material, the band saw 10 can be controlled accordingly (e.g., shut down).

The controller 300 includes a plurality of electrical and electronic components that provide power, operational control, and protection to the components and modules within the controller 300 and/or band saw 10. For example, the controller 300 includes, among other things, a processing unit 305 (e.g., a microprocessor, an electronic processor, an electronic controller, a microcontroller, or another suitable programmable device), a memory 325, input units 330, and output units 335. The processing unit 305 includes, among other things, a control unit 310, an arithmetic logic unit (“ALU”) 315, and a plurality of registers 320 (shown as a group of registers in FIG. 3), and is implemented using a known computer architecture (e.g., a modified Harvard architecture, a von Neumann architecture, etc.). The processing unit 305, the memory 325, the input units 330, and the output units 335, as well as the various modules or circuits connected to the controller 300 are connected by one or more control and/or data buses (e.g., common bus 340). The control and/or data buses are shown generally in FIG. 3 for illustrative purposes. The use of one or more control and/or data buses for the interconnection between and communication among the various modules and components would be known to a person skilled in the art in view of the embodiments described herein.

The memory 325 is a non-transitory computer readable medium and includes, for example, a program storage area and data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 305 is connected to the memory 325 and executes software instruction that are capable of being stored in a RAM of the memory 325 (e.g., during execution), a ROM of the memory 325 (e.g., on a generally permanent basis), or another non-transitory computer readable medium such as another memory or a disc. Software included in the implementation of the band saw 100 can be stored in the memory 325 of the controller 300. The software includes, for example, firmware, one or more applications, program data, filters, rules, one or more program modules, and other executable instructions. The controller 300 is configured to retrieve from the memory 325 and execute, among other things, instructions related to the control processes and methods described herein. In other embodiments, the controller 300 includes additional, fewer, or different components.

A battery pack interface 370 is connected to the controller 300 and couples to the battery pack 26. The battery pack interface 370 includes a combination of mechanical (e.g., a battery pack receiving portion) and electrical components configured to and operable for interfacing (e.g., mechanically, electrically, and communicatively connecting) the band saw 10 with the battery pack 26. The battery pack interface 370 is coupled to power input unit 365. The battery pack interface 370 transmits the power received from the battery pack 26 to the power input unit 365. The power input unit 365 includes active and/or passive components (e.g., voltage step-down controllers, voltage converters, rectifiers, filters, etc.) to regulate or control the power received through the battery pack interface 370 and to controller 300.

The controller 300 drives the motor 18 in response to a user's actuation of the primary trigger 42 (e.g., when operation of the motor 18 is permitted). For example, depression of the primary trigger 42 actuates a trigger switch 345, which outputs a signal to the controller 300 to drive the motor 18, and therefore the blade 34. In some embodiments, the controller 300 controls the switching network 350 (e.g., a FET switching bridge) to drive the motor 18. For example, the switching network 350 may include a plurality of high side switching elements (e.g., FETs) and a plurality of low side switching elements (e.g., FETs). The controller 300 may control each of the plurality of high side switching elements and the plurality of low side switching elements to drive each phase of the motor 18. For example, the power switching network 350 may also be controlled to more quickly deaccelerate or brake the motor 18.

The indicators 360 are also coupled to the controller 300 and receive control signals from the controller 300 to turn on and off or otherwise convey information based on different states of the band saw 10. The indicators 360 include, for example, one or more light-emitting diodes (LEDs), or a display screen. The indicators 360 can be configured to display conditions of, or information associated with, the band saw 10. For example, the indicators 360 can display information relating to whether operation of the band saw 10 is permitted based on signals from the secondary switch 72. In addition to or in place of visual indicators, the indicators 360 may also include a speaker or a tactile feedback mechanism to convey information to a user through audible or tactile outputs. In some embodiments, the indicators 360 are an LED included on the secondary handle 68, as shown in FIGS. 2B-2C.

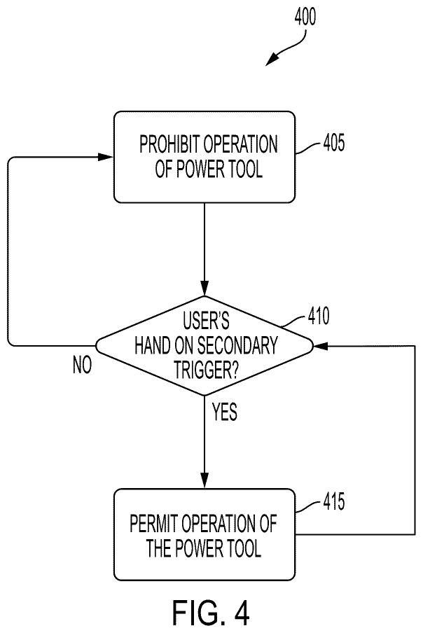

In some instances, the secondary switch 72 operates as a safety mechanism of the band saw 10. For example, the controller 300 may prohibit operation of the motor 18 unless the secondary switch 72 is actuated. FIG. 4 provides a method 400 for allowing use of the band saw 10. FIG. 4 may e performed by the controller 300. At block 405, the controller 300 prohibits operation of the motor 18. For example, when the band saw 10 is not held by a user, the controller 300 defaults to prohibiting operation of the band saw 10. When operation of the band saw 10 is prohibited, the controller 300, for example, ignores any signals from the primary trigger 42.

At block 410, the controller 300 determines whether a user's hand is on the secondary switch 72. For example, the controller 300 determines whether a signal from the touch sensor indicates whether a user's hand is on the secondary switch 72. When a user's hand is not on the secondary switch 72 (“NO” at block 410), the controller 300 returns to block 405 and continues to prohibit operation of the band saw 10. For example, a user may grab the gripping portion 44 of the primary handle 38, but does not grab the secondary handle 68. As the secondary handle 68 is not gripped, the controller 300 ignores any actuation of the primary trigger 42. When a user's hand is on the secondary switch 72 (“YES” at block 410), the controller 300 proceeds to block 415 and permits operation of the band saw 10.

In some implementations, the controller 300 only permits operation of the band saw 10 when the secondary switch 72 is actuated before the primary trigger 42. For example, if the primary trigger 42 is actuated first, and the secondary switch 72 is actuated subsequent to the primary trigger 42, the controller 300 continues to prohibit operation of the band saw 10.

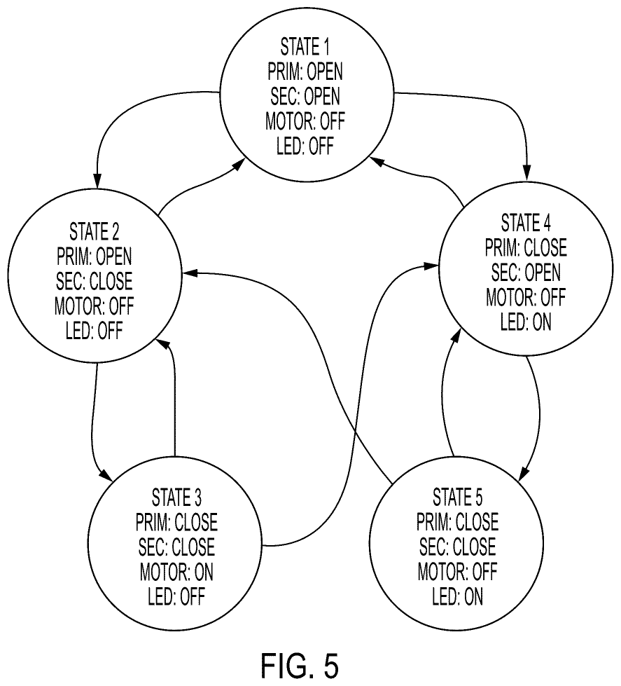

For example, FIG. 5 illustrates a state diagram of the various states of the band saw 10 based on actuation of the primary trigger 42 and the secondary switch 72. In the example of FIG. 5, the indicators 360 include one or more light emitting diodes (LEDs). In state 1, both the primary trigger 42 and the secondary switch 72 are open (e.g., de-actuated). For example, a user does not grip either the primary handle 38 or the secondary handle 68. Accordingly, the motor 18 is off and the indicators 360 are off. If a user grabs the secondary handle 68, the secondary switch 72 becomes closed (e.g., actuated) and the band saw 10 transitions to state 2. In state 2, the primary trigger 42 remains open and the secondary switch 72 is closed. Accordingly, in state 2, the motor 18 remains off and the indicators 360 remain off. From state 2, if a user grabs the primary handle 38 and the primary trigger 42 becomes closed, the band saw 10 transitions to state 3. In state 3, the both the primary trigger 42 and the secondary switch 72 are closed. Additionally, in state 3, the motor 18 is on and driven by the controller 300. The indicators 360 remain off.

While in state 3, should the primary trigger 42 be released while the secondary switch 72 remains actuated, the band saw 10 returns to state 2. However, should the secondary switch 72 be released while the primary trigger 42 remains actuated, the band saw 10 transitions to state 4. In state 4, the primary trigger 42 is closed and the secondary switch 72 is open. Additionally, in state 4, the motor 18 is off and the indicators 360 are on. For example, the indicators 360 may indicate that, although the primary trigger 42 is closed, operation of the motor 18 is prohibited. In some embodiments, the indicators 360 may be an LED that is on or blinking to indicated that operation of the motor 18 is prohibited.

While in state 4, should the secondary switch 72 be closed while the primary trigger 42 remained closed, the band saw 10 proceeds to state 5. In state 5, both the primary trigger 42 and the secondary switch 72 are closed. Additionally, in state 5, the motor 18 is off and the indicators 360 are on. Accordingly, once the secondary switch 72 is released, operation of the motor 18 remains prohibited until the primary trigger 42 is released. While in state 5, should the primary trigger 42 be released, the band saw 10 returns to state 2. Should both the primary trigger 42 and the secondary switch 72 be released at any time during operation, the band saw 10 returns to state 1.

In some instances, the band saw 10 includes a wake sequence that is automatically enabled upon wake up to suspend the typical sequence of activation (such as that described in method 400). For example, if no hand is detected (at either the primary trigger 42 or the secondary switch 72) within a predetermined time period (for example, 3-4 ms), the band saw 10 may become disabled and stop monitoring operations.

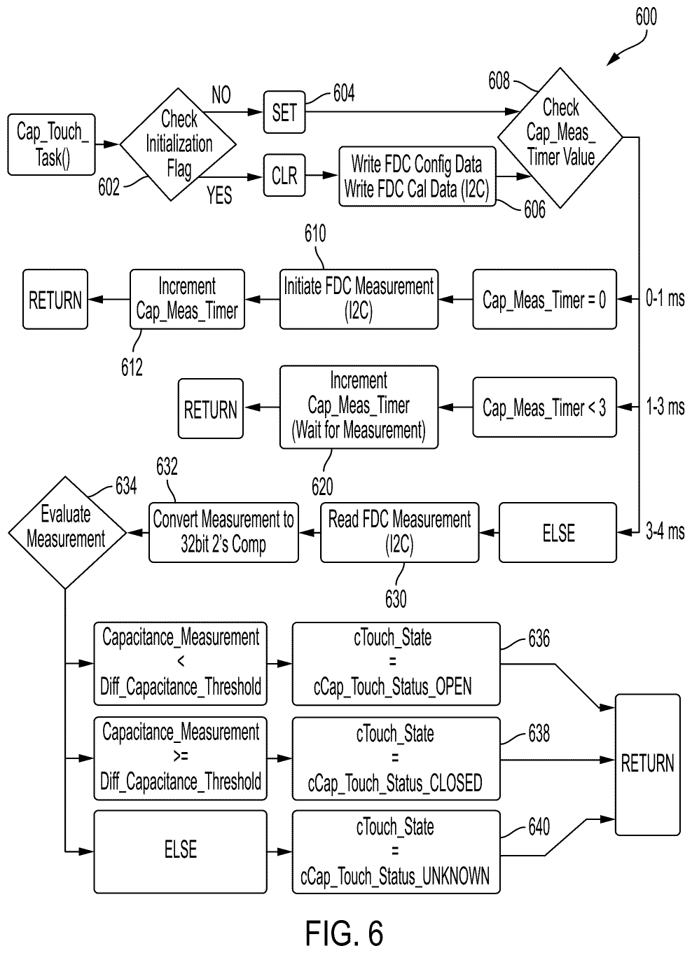

FIG. 6 illustrates a method 600 for a wake sequence of the band saw 10. The method 600 may be performed by the controller 300. When the band saw 10 wakes up from a sleep mode, at block 602 the controller 300 checks whether an initialization flag is set. If the initialization flag is not set, the controller 300 proceeds to block 604 and sets the initialization flag. If the initialization is set, the controller 300 proceeds to block 606 and writes capacitance (FDC) configuration and capacitance calculation data to memory 325.

At block 608, the controller 300 checks a capacitance timer value. When the capacitance timer value is equal to zero (e.g., satisfies a time threshold), the controller 300 proceeds to block 610. When the capacitance value is greater than zero and less than three (e.g., milliseconds), the controller 300 proceeds to block 620. Otherwise, the controller 300 proceeds to block 630. Beginning with when the capacitance timer value is equal to zero, at block 610, the controller 300 initiates a capacitance measurement. At block 612, the controller 300 increments the capacitance timer value and returns to block 602. When the capacitance value is greater than zero and less than three, at block 620, the controller 300 increments the capacitance timer value and returns to block 602 (e.g., waiting for a measurement).

When the capacitance timer value is greater than three (e.g., satisfies a capacitance threshold), at block 630, the controller 300 reads the FDC measurement value. At block 632, the controller 300 converts the capacitance measurement value to, for example, a 32 bit value. At block 634, the controller 300 compares the capacitance measurement to a capacitance threshold. When the capacitance measurement is less than the capacitance threshold, the controller 300 proceeds to block 636 and determines the secondary switch 72 is open (e.g., not actuated, the secondary handle 68 is not held). When the capacitance measurement is greater than or equal to the capacitance threshold, the controller 300 proceeds to block 638 and determines the secondary switch 72 is closed (e.g., actuated, the secondary handle 68 is held). Otherwise, the controller 300 proceeds to block 640 and determines the state of the secondary switch 72 is unknown. Regardless of the comparison result, the controller 300 returns to block 602. In some embodiments, the controller 300 prohibits or permits operation of the motor 18 based on the comparison of the capacitance measurement to the capacitance threshold. In some embodiments, the band saw 10 is permitted to control activation of the motor 18 based on actuation of the primary trigger 42 without receiving a signal from the secondary switch 72. In such embodiments, the band saw 10 and controller 300 enter a wake mode from a sleep mode without the secondary switch 72 being activated (e.g., based on another sensor signal where the secondary switch 72 is not a wake-up source). This functions as a disablement or temporary disablement of a requirement that the secondary switch 72 be activated as described above.

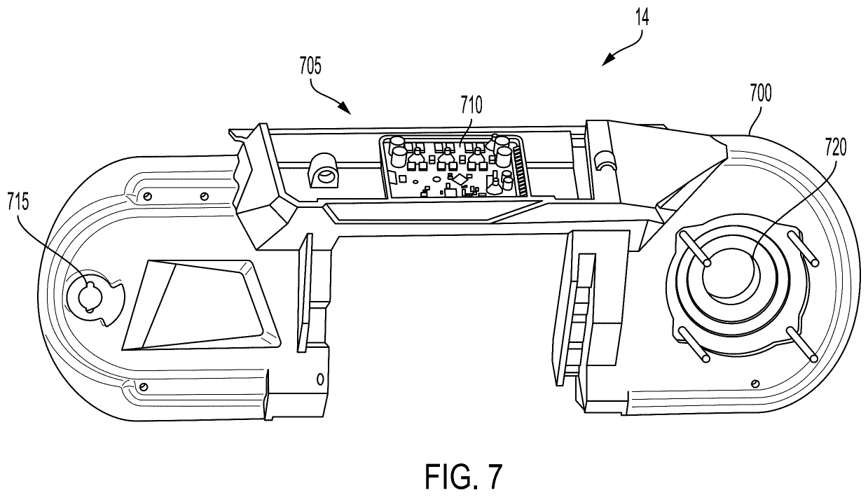

FIG. 7 illustrates a housing portion 700 of the housing 14 of the band saw 10. In the illustrated embodiment, the housing portion 700 of the housing 14 is made of a metallic material. In some embodiments, the housing portion 700 of the housing 14 is referred to as a deck of the band saw 10. The housing portion 700 is configured to function as a heatsink for the band saw 10. As such, an external portion of the housing 14 is configured as a heatsink (e.g., rather than having a heatsink positioned within the housing 14). Because the performance of a heatsink is a function of the thermal mass and surface area of the heatsink, forming an external portion of the housing 14 into a heatsink increases both the thermal mass of the heatsink and the surface area available to dissipate generated heat. The increased thermal mass and surface area of the housing portion 700 acting as a heatsink increases the heatsinking performance of the band saw 10. Using an external portion of the housing 14 as a heatsink also functions to reduce overall material cost, size, and weight of the band saw 10.

The housing portion 700 can include a recessed portion 705 configured to receive a printed circuit board (“PCB”) 710. In some embodiments, a thermally conductive pad can be placed (e.g., situated) between the housing portion 700 and the PCB 710. In some embodiments, the PCB 710 can be potted into the recessed portion 705 using a potting compound to improve ingress protection (e.g., water intrusion). In some embodiments, the housing portion 700 is machined. For example, mounting holes 715, 720 can be machined into the housing portion 700 for assembling the band saw 10. In some embodiments, one or more threaded mounting holes can be machined into the housing portion 700 for securing the PCB 710 to the housing portion 700 and/or for assembling the band saw 10. In some embodiments, the housing portion 700 is first cast and then machined in a fashion similar to that described above.

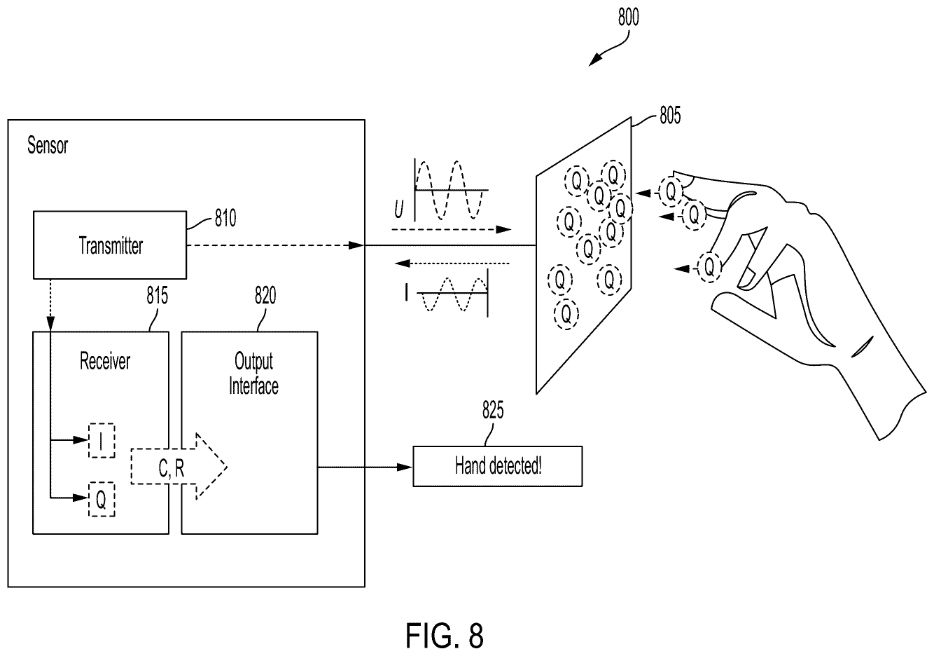

FIG. 8 illustrates a sensor 800 included in the sensors 355. The sensor 800 is, for example, an impedance sensor 800. The impedance sensor 800 includes a surface 805 that can be contacted by a user or an object. The impedance sensor 800 also includes a transmitter 810, a receiver 815, an output interface 820, and produces an output signal 825 that is received by the controller 300. The output signal 825 can, for example, provide an indication or whether a user's hand has been detected. In some embodiments, the output signal 825 is provided to the controller 300 and the controller 300 is configured to determine whether a user's hand has been detected.

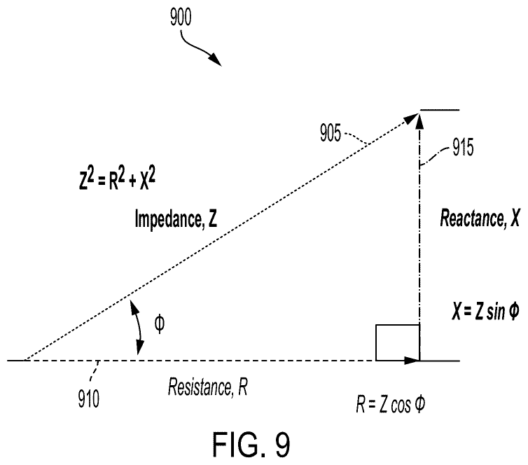

The transmitter 810 provides a load sine wave to the surface 805. The receiver 815 receives a current response of the load. A change in the current (e.g., in phase and modulus) can be sensed. The current response is converted to a voltage 900 and then demodulated into an in-phase component and a quadrature component, as shown in FIG. 9. With reference to FIG. 9, a sensed or detected impedance 905 includes the in-phase component and the quadrature component. The in-phase component corresponds to a resistive component 910 of the detected impedance 905. The quadrature component corresponds to a reactive component 915 of the detected impedance 905. In some embodiments, the frequency of the sine wave from the transmitter 810 is between 30 kilo-Hertz (“kHz”) and 150 kHz. Based on the changes in the resistive and reactive components of the detected impedance 905, the controller 300 is configured to determine, for example, whether a user is gripping the secondary handle 68. In some embodiments, the band saw 10 is configured to distinguish between, for example, a human hand gripping the secondary handle 68 and an inanimate object that may be contacting the band saw 10.

Thus, embodiments provided herein describe, among other things, systems and methods for a band saw having a touch sensor.

What is claimed is:

1. A band saw comprising:
a housing;
a motor located within the housing;
a first handle including a first trigger configured to be actuated by a user, wherein a first hand of the user may be detected on the first handle based on actuation or de-actuation of the first trigger;
a second handle including a touch sensor, wherein the touch sensor is configured to detect a second hand of the user on the second handle; and
a controller connected to the motor, the first trigger, and the touch sensor, the controller configured to:
determine that the touch sensor is actuated by the user,
determine that the first trigger is actuated by the user after the touch sensor is actuated by the user, and
drive, in response to the touch sensor being actuated and in response to the first trigger being actuated after the touch sensor is actuated, the motor.

2. The band saw of claim 1, wherein the controller is configured to:
determine, while the motor is being driven, that the first trigger is released by the user; and
stop, in response to the first trigger being released, drive of the motor.

3. The band saw of claim 1, wherein the controller is configured to:
determine, while the motor is being driven, that the second handle is released by the user; and
stop, in response to the second handle being released, driving the motor.

4. The band saw of claim 3, further comprising an indicator configured to provide an indication, and wherein the controller is configured to:
prohibit, in response to the second handle being released while the first trigger remains actuated, operation of the motor; and
control, in response to the second handle being released while the first trigger remains actuated, the indicator to provide the indication.

5. The band saw of claim 4, wherein the controller is configured to:
determine that the touch sensor is actuated by the user while the first trigger remains actuated; and
continue, in response to determining that the touch sensor is actuated by the user while the first trigger remains actuated, prohibition of operation of the motor.

6. The band saw of claim 4, wherein the controller is configured to:
determine that the first trigger is released by the user; and
permit, in response to the first trigger being released and the second handle being released, operation of the motor.

7. The band saw of claim 1, wherein, to determine that the touch sensor is actuated by the user, the controller is configured to:
set, in response to initiation of a wake sequence, an initialization flag;
compare a capacitance timer to a time threshold;
compare, in response to the capacitance timer satisfying the time threshold, a capacitance value of the touch sensor to a capacitance threshold; and
determine, in response to the capacitance value satisfying the capacitance threshold, that the touch sensor is actuated by the user.

8. The band saw of claim 7, wherein the controller is configured to:
increment, in response to the capacitance timer not satisfying the time threshold, the capacitance timer.

9. The band saw of claim 1, wherein the housing includes an external portion configured as a heatsink.

10. The band saw of claim 9, wherein the housing includes:
a recessed portion configured to receive a printed circuit board; and
a thermally conductive pad positioned between the external portion and the printed circuit board.

11. The band saw of claim 1, wherein the touch sensor is an impedance sensor.

12. A method for controlling a band saw, the method comprising:
determining that a touch sensor is actuated by a user, wherein the touch sensor is configured to detect a second hand of the user on a second handle;
determining that a first trigger is actuated by the user after the touch sensor is actuated by the user, wherein a first hand of the user may be detected on a first handle based on actuation or de-actuation of the first trigger; and
driving, in response to the touch sensor being actuated and in response to the first trigger being actuated after the touch sensor is actuated, a motor.

13. The method of claim 12, further comprising:
determining, while the motor is being driven, that the first trigger is released by the user; and
stopping, in response to the first trigger being released, driving the motor.

14. The method of claim 12, further comprising:
determining, while the motor is being driven, that the second handle is released by the user; and
stopping, in response to the second handle being released, driving the motor.

15. The method of claim 14, further comprising:
prohibiting, in response to the second handle being released while the first trigger remains actuated, operation of the motor; and
controlling, in response to the second handle being released while the first trigger remains actuated, an indicator to provide an indication.

16. The method of claim 15, further comprising:
determining that the touch sensor is actuated by the user while the first trigger remains actuated; and
continuing, in response to determining that the touch sensor is actuated by the user while the first trigger remains actuated, prohibiting operation of the motor.

17. The method of claim 15, further comprising:
determining that the first trigger is released by the user; and
permitting, in response to the first trigger being released and the second handle being released, operating the motor.

18. A band saw comprising:
a housing;
a motor located within the housing;
a first handle including a first trigger configured to be actuated by a user, wherein a first hand of the user may be detected on the first handle based on actuation or de-actuation of the first trigger;
a second handle including an impedance sensor, wherein the impedance sensor is configured to detect a second hand of the user on the second handle; and
a controller connected to the motor, the first trigger, and the impedance sensor, the controller configured to:
determine, based on changes in resistive and reactive components of an impedance value provided by the impedance sensor, that the impedance sensor is actuated by the user,
determine that the first trigger is actuated by the user after the impedance sensor is actuated by the user, and
drive, in response to the impedance sensor being actuated and in response to the first trigger being actuated after the impedance sensor is actuated, the motor.

19. The band saw of claim 18, wherein the housing includes an external portion configured as a heatsink.

20. The band saw of claim 19, wherein the housing includes:
a recessed portion configured to receive a printed circuit board; and
a thermally conductive pad situated between the external portion and the printed circuit board.
